(19) United States
(12) Patent Application Publication
(10) Pub. No.: US 2011/0102152 A1
(43) Pub. Date: May 5, 2011

(54) DOUBLE SIDE IDENTIFICATION NOTATION-CONTAINING TEST STRIP AND TEST INSTRUMENT THEREOF

(75) Inventor: TIEN-TSAI HSU, HSINCHU (TW)

(73) Assignee: HMD BIOMEDICAL INC., HSINCHU COUNTY (TW)

(21) Appl. No.: 12/917,616

(22) Filed: Nov. 2, 2010

(30) Foreign Application Priority Data
Nov. 3, 2009 (TW) 098137237

(51) Int. Cl. H04Q 5/22

(52) U.S. Cl. 340/10.1

(57) ABSTRACT

A double side identification notation-containing test strip and test instrument thereof, comprising: a substrate, having a first surface and a second surface, and at least a test area and an identification area provided thereon, hereby forming a double side identification notation-containing test strip. In said double side identification notation-containing test strip, a test area and an identification area are disposed respectively on different surfaces, thus increasing area of said identification area and sets of digital identification electrodes, and when it is operated in cooperation with a resistor, it generates a plurality sets of analog identification signals, hereby solving the problem of insufficient identification signals of the prior art.

### BACKGROUND OF THE INVENTION

1. Field of the Invention

The present invention relates to a test strip, and in particular to a double side identification notation-containing test strip and test instrument thereof used for biological test.

2. The Prior Arts

Along with the progress and development of biological test technology, quite a few test items such as biochemical, immunoassay, and gene tests, that in the past originally have to be performed by medical professionals, for example doctors, test technicians, researchers in specific locations such as hospitals, test rooms, and laboratories by means of sophisticated instruments, but presently, they can be carried out in a clinic, or even in the home life of the patient, as conducted by the patient himself; such a technology is now referred to as Point of Care Test (POCT). The ordinary POCT biochemical test items include: blood glucose test, cholesterol test, uric acid test; while the immunoassay test items include: pregnancy test, drug abuse test, cancer indicator test, hemoglobin A1c test, and intestinal virus gene test, etc. This technology and its derived products can not only be used in biomedicine, but it can also be applied in veterinary, agriculture, environment protection (such as pesticide test) and other related industries.

For the POCT test strips presently available on the market, in application, after the sample is dropped onto the test strip, the analyte of the sample will produce chemical reactions with the material in an absorption area or a test area, thus causing optical, electrical charges variations in the absorption area or test area, then test instrument is used to measure, calculate and obtain the concentration of the analyte of the sample.

Refer to FIG. 1 for a biological test strip of the prior art. As shown in FIG. 1, for an electrochemical test strip 10 having identification electrodes, an electrochemical test area 14 and a digital identification electrode area 16 are provided on a substrate 12, and the test area 14 is connected to an working electrode 18 and a counter electrode 17. However, in this configuration, the digital identification electrode area 16 and electrochemical test area 14 are located on the same surface of the substrate, such that due to the restriction of the width of the strip and the width of spacing between connection points of a connector, the number of identification electrodes 19 that can be provided is rather limited. In order to solve the problem, in case that the width of the identification electrode 19 is narrowed, that will increase difficulty in manufacturing while producing inferior contact, hereby causing difficulty in testing.

Therefore, presently, the design and performance of the test strip of the prior art are not quite satisfactory, it leaves much space to improve.

### SUMMARY OF THE INVENTION

In view of the drawbacks and shortcomings of the prior art, the present invention provides a double side identification notation-containing test strip and test instrument thereof, so as to solve the problems and shortcomings of the prior art.

A major objective of the present invention is to provide a double side identification notation-containing test strip and test instrument thereof, such that in this double side structure, the identification area and the test area are located respectively on two different surfaces of a test strip, or the identification areas are located on both surfaces of a test strip, so as to increase the area of the identification area.

Another objective of the present invention is to provide a double side identification notation-containing test strip and test instrument thereof, wherein, the identification area is composed of digital identification electrodes and resistors, so as to generate a plurality sets of digital signals and analog signals in solving the problems of the prior art that number of identification electrodes is not enough.

In order to achieve the above-mentioned objective, the present invention provide a double side identification notation-containing test strip, including a substrate, having a first surface and a second surface; a test area disposed on the first surface, the test area can be an electrochemical test area, an optical test area, or an immunoassay test area; and an identification area, disposed on the second surface or on both the first surface and the second surface, and the identification area contains at least a digital identification electrode, so that the identification area may produce a digital identification signal, the digital identification electrode is connected to at least a resistor in parallel, so as to generate an analog identification signal, such that when there are a plurality of digital identification electrodes, at least a digital identification electrode is of an open circuit structure.

The identification area is provided with N digital identification electrodes, so as to generate 2^{N} sets of different digital identification signals, the resistor is provided with m resistance values, hereby being able to generate m different analog signals; the digital identification electrodes are formed on the second surface or the first surface in advance, then the open circuit structure is formed based on different processing methods. The processing method can be punching, cutting, or laser (engraving), or it is printed directly as short circuit or open circuit structure while printing the digital identification electrodes.

The present invention further provides a test instrument for a double side identification notation-containing test strip, with one test inlet of the test instrument provided with a detector inside, such that when a test strip is inserted into the test inlet, the identification area of the test strip corresponds to the detector, so as to generate a digital identification signal and an analog identification signal for the test instrument.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a biologic test strip of the prior art;

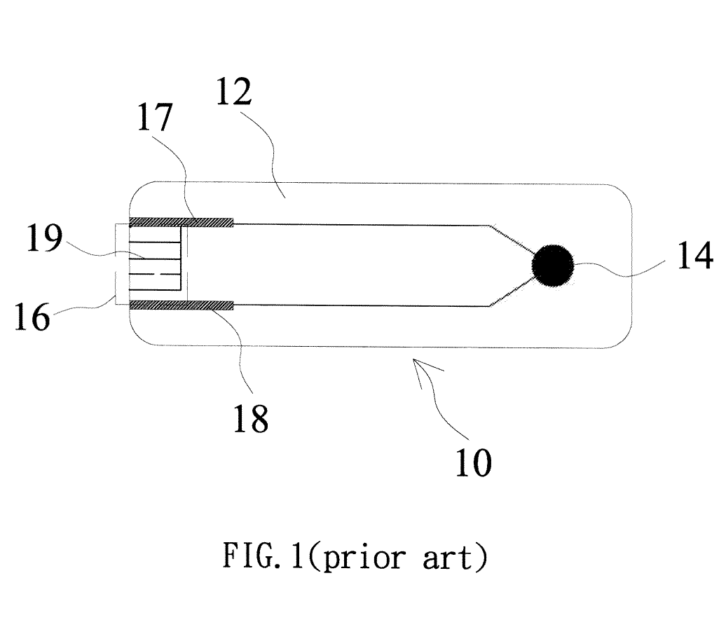

FIG. 2(A) is a schematic diagram of is a double side identification notation-containing test strip according to a first embodiment of the present invention;

FIG. 2(B) is a schematic diagram of is a double side identification notation-containing test strip viewed from another angle according to a first embodiment of the present invention;

FIG. 3 is a schematic diagram of is a double side identification notation-containing test strip according to a second embodiment of the present invention;

FIG. 4 is an exploded view of is a double side identification notation-containing test strip according to a second embodiment of the present invention;

FIG. 5 is a schematic diagram of is a double side identification notation-containing test strip according to a third embodiment of the present invention;

FIG. 6 is a schematic diagram of is a double side identification notation-containing test strip according to a fourth embodiment of the present invention;

FIG. 7 is a schematic diagram of a test instrument for a double side identification notation-containing test strip according to an embodiment of the present invention;

FIG. 8 is a schematic diagram of an operation architecture of a test strip and an electronic connector according to the present invention; and

FIG. 9 is a schematic diagram of identification electrode variations when the test strip is provided with 3 digital identification electrodes according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

The present invention provides a brand new double side identification notation-containing test strip, so as to solve the shortcomings and drawbacks of the conventional test strip that the test area and identification area are located on the same surface of a substrate. The essence of the design of the present invention is that at least a portion of the identification area is disposed on a surface of the substrate opposite to that of test area, so that the area of the identification area can be more sufficient, hereby increasing significantly the number of the identification electrodes available. As such, in the spirit of the present invention, various modifications and combination with other technologies will not depart from the scope of the present invention. By way of example, the test strip of the present invention can be an electrochemical test strip, an optical test strip, or an immunity test strip, or it can be an identification electrode type, such as digital type, a resistor type, or a combination of both; all of the test strips mentioned above can be utilized as a double side identification notation-containing test strip of the present invention.

In the following, various embodiments of the present invention are described in explaining the principles of the present invention, however, the present invention is not limited to this.

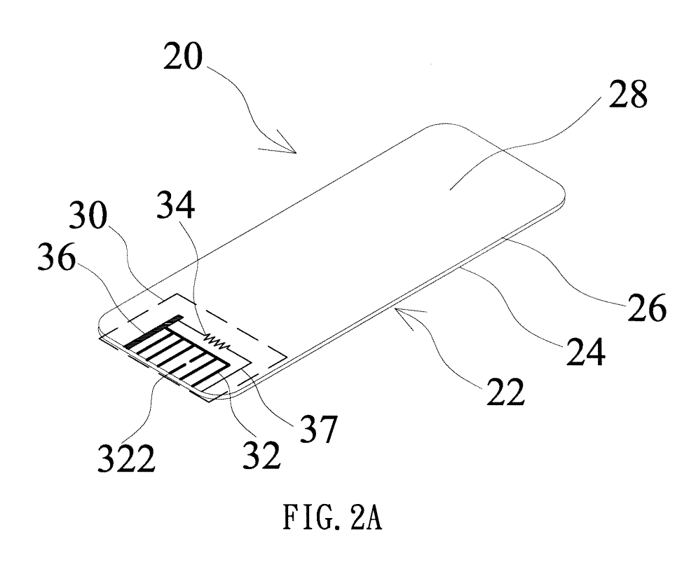

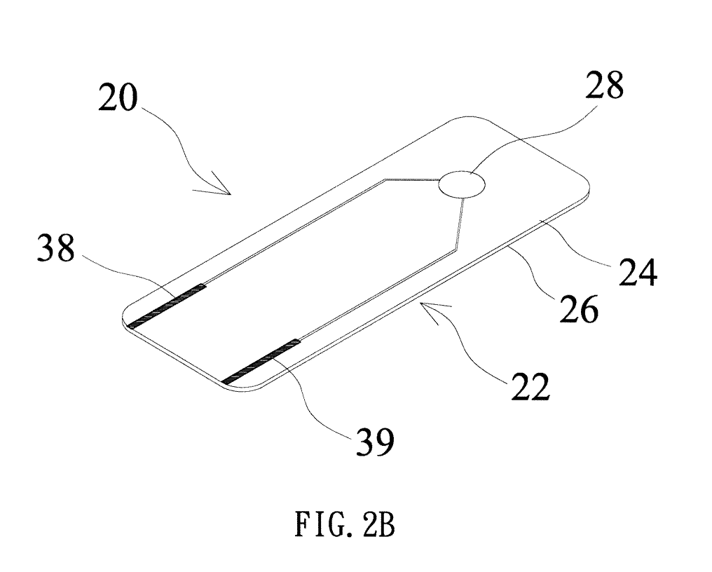

Firstly, refer to FIG. 2(A) and FIG. 2(B) simultaneously for a schematic diagram of a double side identification notation-containing test strip showing a first surface 24 and a second surface 26, and a schematic diagram of the same as viewed from another angle according to a first embodiment of the present invention, As shown in FIG. 2(A) and FIG. 2(B), the double side identification notation-containing electrochemical test strip 20 of the present invention comprises: a substrate 22, having a first surface 24 and a second surface 26; at least a test area 28 disposed on the first surface 24, the test area 28 can be an electrochemical test area, an optical test area, or an immunity test area. In the present embodiment, the test area 28 is an electrochemical test area and is connected respectively to an working electrode 38 and a counter electrode 39; and an identification area 30, disposed on a second surface 26, and is provided with at least a digital identification electrode 32, so as to generate a digital identification signal.

Moreover, as shown in the embodiment of the present invention, the digital identification electrode 32 can be connected with at least a resistor 34 in parallel to generate an analog identification signal. The digital identification electrode 32 is coupled to a ground electrode 36, and the resistor 34 is connected across between a ground electrode 36 and an analog identification electrode 37 after it is connected with the digital identification electrode 32 in parallel, for generating an analog identification signal.

In case that a plurality of digital identification electrodes 32 are provided, in order to provide much more different identification signals, perform punching, cutting, laser (engraving) etc. for at least one of the digital identification electrodes 32 based on different parameters or conditions, so as to form open circuit structure; or when printing a digital identification electrode 32, printing it directly as a short circuit or open circuit structure, so that when it is connected electrically to a test instrument, it is able to generate digital identification signals of 0 or 1. By way of example, in the present embodiment, since 6 identification electrodes are provided, thus it can produce 2⁶ sets of digital identification signals. In FIG. 2(A), one digital identification electrode 322 in the identification area 30 is in open circuit state, and the rest electrodes remain in short circuit state. Since the digital identification electrode 322 is of an open circuit structure, and the identification area is provided with N digital identification electrodes, thus it can generate 2^{N} sets of different digital identification signals. In the present embodiment, since 6 digital identification electrodes are provided, thus 2⁶ sets of digital identification signals can be generated.

Furthermore, when the test strip of the present embodiment is provided with resistor 34, since the resistor is capable of having m resistance values, so it may produce m different analog signals, wherein m≧1, such that the test strip may generate m×2⁶ sets of identification signals.

In the above description, different resistance values of a resistor can be realized through utilizing different resistor paste and composition, in generating different analog identification signals.

The digital identification signal and/or analog identification signals mentioned above can be used to indicate test codes and parameters, expiration date settings, batch settings, customer classifications, or production process parameters, and that are used to distinguish for example lactose test strip, cholesterol test strip, and blood glucose test strip.

In manufacturing, firstly, the digital identification electrode 32 and resistor 34 are formed on the second surface 26 of the substrate 22, or they are formed on the first surface 24 and the second surface 26 respectively at the same time, as based on different parameters and conditions. For example, the resistance values of a printed resistor can be determined based on the product classifications.

Wherein, the resistor 34 is made by printing resistor paste, which can be chosen from metals, metal alloys, or conductive inks, such as thick film resistor (TFR), carbon paste, or carbon lacquer, etc.

When an electrochemical test strip 20 is inserted into a test instrument (not shown), the identification area 30 of the test strip will contact the test instrument electrically, in generating digital identification signal for the test instrument to make determination as required. As such, the test strip of the present invention is able to generate various identification signals based on the short circuit or open circuit state of the digital identification electrode 3 and the resistance of the resistor 34.

In the embodiment mentioned above, the identification area uses digital identification signal to make identification, or it may further utilize analog identification signal in combination. However, to people familiar with this technology, analog identification signal can be utilized alone to achieve the same purpose. Yet to people familiar with this technology, the utilization of digital identification signal or analog identification signal is only a matter of simple replacement, and the present invention is not limited to this.

The double side identification notation-containing test strip of the present invention can be realized through a single substrate having a first surface and a second surface, as in the first embodiment mentioned above. However, other structures such as a double side structure formed by binding a first substrate and second substrate together, can also be utilized as described as follows.

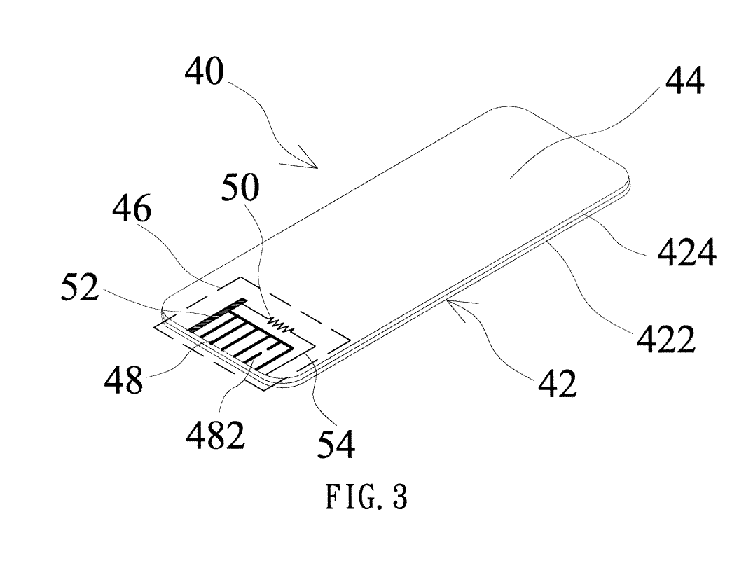

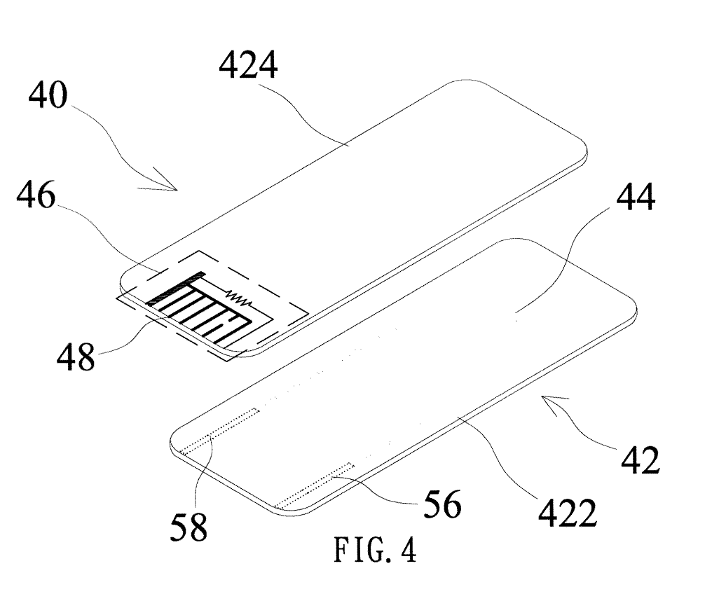

Refer simultaneously to FIGS. 3 and 4 for a schematic diagram and a perspective view respectively of a double side identification notation-containing test strip according to a second embodiment of the present invention. As shown in FIGS. 3 and 4, a substrate 42 of a test strip 40 further includes a first substrate 422 and a second substrate 424 bound together; on the first substrate 422 is provided with a test area 44, that is an electrochemical test area, and is connected to an working electrode 56 and a counter electrode 58 respectively; and on the second substrate 424 is disposed an identification area 46, which is provided with at least a digital identification electrode 48, such that the identification area 46 is able to generate a digital identification signal.

The identification area 46 is further provided with at least a resistor 50, connected in parallel with a digital identification electrode 48 for generating an analog identification signal. The digital identification electrode 48 is coupled to a ground electrode 52, and a resistor 50 is connected across between the ground electrode 52 and an analog identification electrode 54, after connecting in parallel with a digital identification electrode 48. The digital identification signal and/or analog identification signals are used to indicate test codes and parameters, expiration date settings, batch settings, customer classifications, or production process parameters, and that are used to distinguish for example lactose test strip, cholesterol test strip, and blood glucose test strip, etc. In addition, digital identification electrode 48 and resistor 50 are formed on the second substrate 424 in advance.

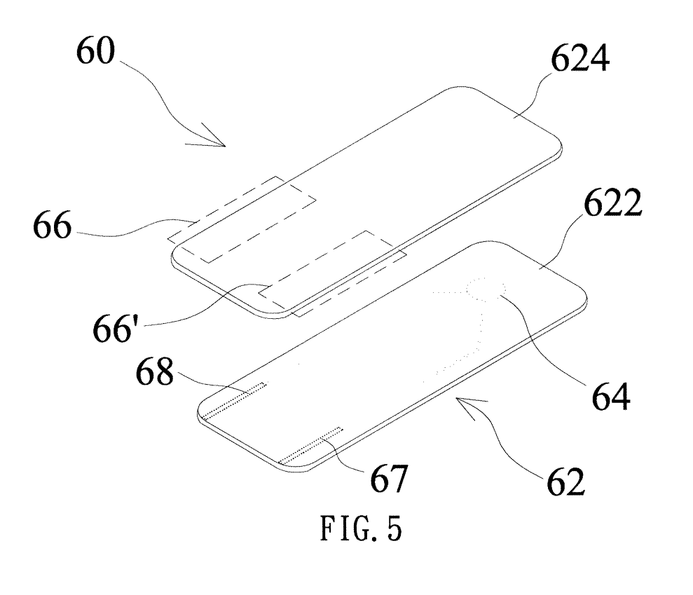

Furthermore, the identification areas of the embodiment mentioned above are disposed at the bottom of the substrates. Subsequently, refer to FIG. 5 for a schematic diagram of is a double side identification notation-containing test strip according to a third embodiment of the present invention. Wherein, in addition to being provided at the bottom of the substrate as in the previous embodiment, the identification area can also be disposed on the sides of a substrate.

As shown in FIG. 5, the substrate 62 of a test strip 60 further includes a first substrate 622 and a second substrate 624, on the first substrate 622 is provided with a test area 64, that is an electrochemical test area; and on the sides of the second substrate 624 are provided each with an identification area 66 and an identification area 66′.

As mentioned in the previous embodiment, the identification area 66 and identification area 66′ are each provided with at least a digital identification electrode or further with a corresponding resistor (not shown), so that the identification areas 66 and 66′ may generate digital identification signals and/or analog identification signals. A test area 64 is provided on the outer surface of the first substrate 622. In the present embodiment, the test area 64 is an electrochemical test area, connected respectively to an working electrode 67 and a counter electrode 68; and the first substrate 622 and the second substrate 624 can be bound to each other, to form a test strip of double-side structure.

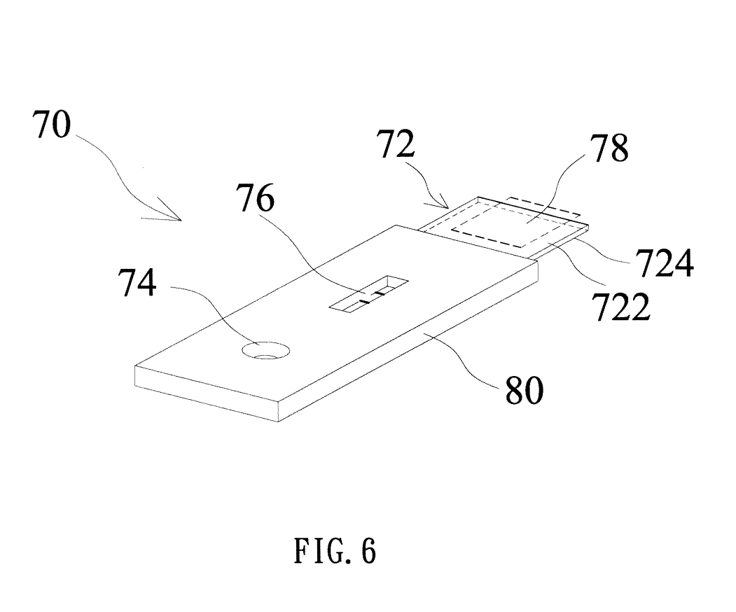

Then, refer to FIG. 6 for a schematic diagram of is a double side identification notation-containing test strip according to a fourth embodiment of the present invention. As shown in FIG. 6, the test strip 70 is an immunoassay test strip, comprising: a substrate 72 having a first surface 722 and a second surface 724, on the first surface is provided with an absorption area 74, a test area 76, and on the second surface 724 is provided with an identification area 78; and a shell 80, enclosing a part of the substrate 72, and exposing the absorption area 74, the test area 76, and the identification area 78, wherein, the test area 76 is a color reaction/colorimetric area, the identification area 78 is provided with a digital identification electrode and/or resistor (not shown) to generate digital identification signal and/or analog identification signals. Wherein, digital identification signal and/or analog identification signal are used to indicate test codes and parameters, expiration date settings, batch settings, customer classifications, or production process parameters, and that are used to distinguish for example the pregnancy test strip and pesticide test strip, etc.

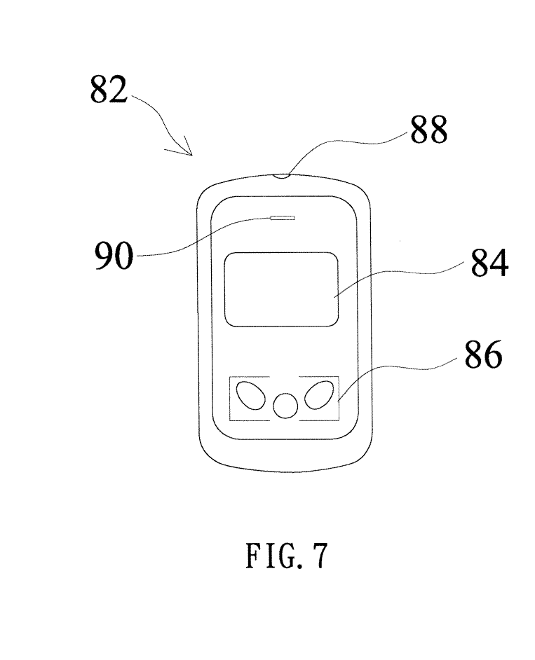

Subsequently, refer to FIG. 7 for a schematic diagram of a test instrument for a double side identification notation-containing test strip according to an embodiment of the present invention. As shown in FIG. 7, the test instrument 82 includes a display screen 84 and a set of control push buttons 86; and s test inlet 88 utilized as a test strip insertion inlet, with its inside provided with a detector 90, such as an electronic crosspoint connector. In operation, aligning and inserting one end of identification area of a test strip into the test inlet 88 of the test instrument, such that the identification area of the test strip is located correspondingly to the detector 90, as such the detector 90 is able to detect the digital and analog identification signals generated by the identification electrode and resistor of the test strip, for determining further its corresponding test codes and parameters, expiration date or batch settings, or production process parameters. In addition, inside the test instrument 82 is further provided a microprocessor (not shown) for analyzing test data of samples. Since it belongs to the prior art and is not the technical characteristic of the present invention, it will not be repeated here for brevity.

Therefore, in the present invention, for the a double side identification notation-containing test strip, the original design of the identification area and the test area on the same surface is changed into a different design that, all or a part of identification area and the test area are placed on different surfaces, so as to increase the area of identification area, such that more sets of identification electrodes can be provided, and the signal transmission is improved, when the test strip and test instrument are in contact. In addition, the identification areas can be placed on two sides of the test strip, therefore, more sets of identification electrodes can be provided, and in cooperation with the placement of resistor, a plurality sets of digital identification signals and analog identification signals can be generated, hereby solving the problem of insufficient identification signals of the prior art.

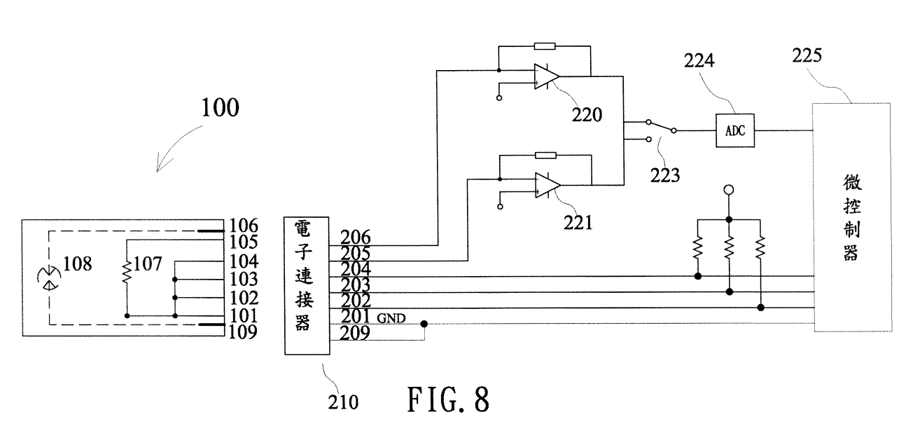

Refer to FIG. 8 for a schematic diagram of an operation architecture of a test strip and an electronic connector according to the present invention. As shown in FIG. 8, when a test strip 100 is inserted into an electronic connector 210, the ground electrode 101 is connected to a connection point 201 of the electronic connector 210, the digital identification electrode 102 is connected to the connection point 202 of the electronic connector 210, the digital identification electrode 103 is connected to the connection point 203 of the electronic connector 210, the digital identification electrode 104 is connected to the connection point 204 of the electronic connector 210, and the analog identification electrode 105 is connected to the connection point 205 of the electronic connector 210.

In the present embodiment, digital identification electrodes 102 to 105 and the test area 108 are on different surfaces of a substrate, so that working electrode 106 is connected to the connection point 206 of the electronic connector 210, and the counter electrode 109 is connected to the connection point 209 of the electronic connector 210. In case that digital identification electrodes 102 to 105 and the test area 108 are on the same surface of a substrate, then the ground electrode 101 and counter electrode 109 can be the same electrode, and is connected to the connection point 201 of the electronic connector 210.

The resistor 107 can have m resistance values for generating m different analog signals, that are transmitted to an amplifier 221 via an analog identification electrode 105 and a connection point 205 of the electronic connector, then after amplification, the signal is transmitted to a microprocessor 225 via a multiplexer 223 and an analog-to-digital converter (ADC) 224, so from the microprocessor 225 we can get m different resistance values to distinguish m different resistors.

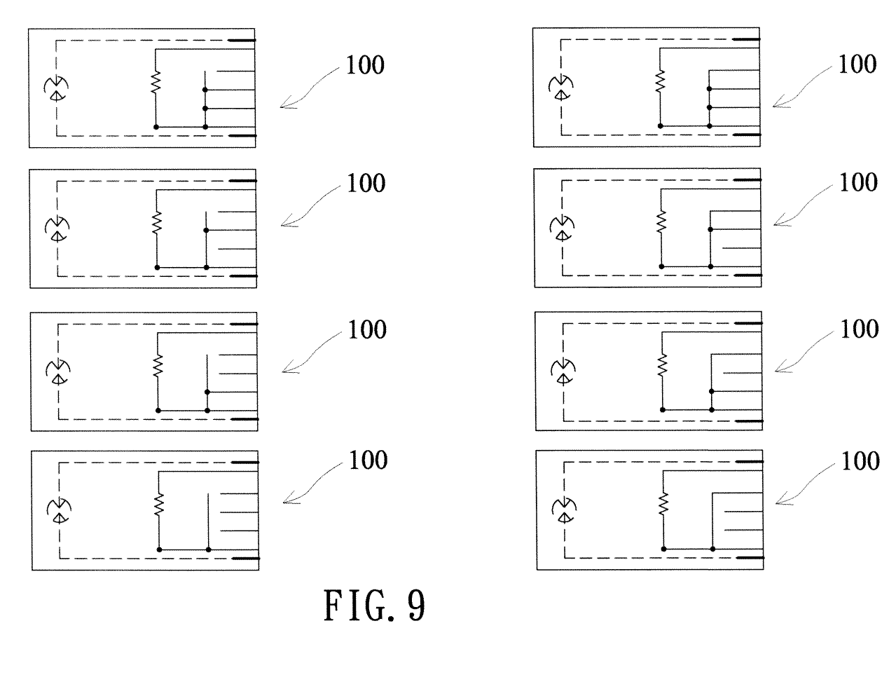

The digital identification area can be provided with N digital identification electrodes for generating 2^{N} sets of different digital identification signals. As shown in FIG. 8, in case that N=3, then the digital identification signals will reach the microprocessor 225 via three digital identification electrodes 102,103,104, connection points 202,203,204 of the electronic connector, thus from microprocessor 225 we can get 2³=8 combinations of different digital identification signals, as shown in FIG. 9, so as to distinguish test strips of 2³=8 sets of different digital identification signals.

Through the different combinations of digital and analog identification signals mentioned above, and from microprocessor 225 we can get m×2^{N} combinations of different identification signals, so as to distinguish test strips of m×2^{N} sets of different identification signals.

By way of example, when enzyme and blood glucose (or other biological material) are put onto the test area 108 to induce electrical and chemical reactions, a weak current signal is produced between a counter electrode 109 and an working electrode 106, and that is transmitted to an amplifier 220 via the working electrode 106 and the connection point 206 of the electronic connector, then after amplification, the signal is transmitted to a microprocessor 225 via a multiplexer 223 and an analog-to-digital converter (ADC) 224, so from the microprocessor 225 we can get m×2^{N} sets of built-in parameters, and from which we can select a set of digital and analog identification electrodes just correspond to the test strip, then after calculation and compensation, we can get the blood glucose concentration corresponding to that weak current signal (or other biological sensor signal).

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A double side identification notation-containing test strip, comprising:
a substrate, provided with a first surface and a second surface;
at least a test area, disposed on said first surface; and
at least an identification area, disposed entirely on said second surface, or disposed in part on said first surface and said second surface respectively, and said identification area is provided with at least an identification electrode, so that said identification area generates an identification signal.

2. The double side identification notation-containing test strip as claimed in claim 1, wherein said identification electrode is selected from a digital identification electrode, an analog identification electrode, or a combination of both.

3. The double side identification notation-containing test s p as claimed in claim 2, wherein when said identification electrode is said combination of said digital identification electrode and said analog identification electrode, then at least a said digital identification electrode and at least a resistor are connected in parallel, in generating a digital identification signal of 0 or 1 and an analog identification signal.

4. The double side identification notation-containing test strip as claimed in claim 2, wherein when said identification electrode includes a plurality of said digital identification electrodes, at least one said digital identification electrode contains an open circuit structure.

5. The double side identification notation-containing test strip as claimed in claim 2, wherein when said identification electrode includes N said digital identification electrodes, it generates sets of said different digital identification signals of 0 or 1.

6. The double side identification notation-containing test strip as claimed in claim 3, wherein said resistor has m resistance values, and generates m said different analog identification signals, wherein m≧1.

7. The double side identification notation-containing test strip as claimed in claim 4, wherein said open circuit structure is formed based on different processing method after formation of said digital identification electrode, or it is formed while printing said digital identification electrode.

8. The double side identification notation-containing test strip as claimed in claim 7, wherein said processing method is punching, cutting, or laser (engraving).

9. The double side identification notation-containing test strip as claimed in claim 1, wherein said substrate is formed by binding a first substrate and a second substrate to each other, said test area is disposed on said first substrate, and said identification area is disposed entirely on said second substrate, or disposed in part on said first substrate and said second substrate respectively.

10. The double side identification notation-containing test strip as claimed in claim 1, further comprising: a shell, used to enclose said substrate and expose said identification area and said test area.

11. The double side identification notation-containing test strip as claimed in claim 1, wherein said test area is an electrochemical test area, an optical test area, or an immunoassay test area.

12. The double side identification notation-containing test strip as claimed in claim 1, wherein said identification signal is used to indicate test codes and parameters, expiration date settings, batch settings, customer classifications, or production process parameters, and are used to distinguish a lactose test strip, a cholesterol test strip, a blood glucose test strip, a pregnancy test strip, or a pesticide test strip, etc.

13. The double side identification notation-containing test strip as claimed in claim 1, wherein said identification area disposed on said second surface is located on bottom of said second surface, or on sides of said substrate.

14. A test instrument utilizing a double side identification notation-containing test strip as claimed in claim 1, wherein a detector is disposed in a test inlet, such that when said test strip is inserted into said test inlet, an identification area is located correspondingly to said detector, so as to utilize said detector to detect an identification electrode of said identification area, for generating and supplying an identification signal to said test instrument.
